(19) United States
(12) Patent Application Publication
(10) Pub. No.: US 2025/0354094 A1
(43) Pub. Date: Nov. 20, 2025

(54) LOW-ALCOHOL OR ALCOHOL-FREE COMPOSITIONS, AND METHODS TO PRODUCE THEREOF

(71) Applicants: UNIVERSIDADE DE AVEIRO, Aveiro (PT); SOGRAPE VINHOS SA, Avintes (PT)

(72) Inventors: Sílvia Maria DA ROCHA SIMÕES CARRIÇO, Vagos (PT); André Gustavo FARIA ALVES DA SILVA, Espinho (PT); Natacha Sofia MIRANDA FONTES, Braga (PT); António Américo DA ROCHA GRAÇA, Arcozelo VNG (PT)

(21) Appl. No.: 18/870,677

(22) PCT Filed: May 29, 2023
(86) PCT No.: PCT/EP2023/064342

§ 371 Date: Dec. 1, 2024

(30) Foreign Application Priority Data
May 30, 2022 (PT) 118018

(51) Int. Cl. C12G 1/14; B01D 61/02; B01D 61/14; B01D 61/24; B01D 61/58; B01D 69/02; C12G 1/022; C12H 3/02; C12H 3/04

(52) U.S. Cl. CPC C12G 1/14; B01D 61/243; B01D 61/58; B01D 69/02; C12G 1/0203; C12H 3/02; C12H 3/04; B01D 61/027; B01D 61/145; B01D 2325/20

(57) ABSTRACT

The present disclosure is directed to a method for producing a non-alcoholic liquid product or a low-alcoholic liquid product, the method comprising nanofiltration, ultrafiltration, dialysis, or any combination thereof, of a grape mash with a sugar concentration from 8° Brix to 18° Brix, thereby obtaining a mixture with a sugar concentration from 10% to 50% less than the sugar concentration of said grape mash; and fermenting said mixture with one or more yeast during a period of time from 4 days to 8 days, thereby obtaining a liquid product. Compositions obtained by the method, additives comprising propane-1,2,3-triol, propan-1-ol, quinine hydrochloride, or any combination thereof, particularly from 3 g/L to 12 g/L of propane-1,2,3-triol, from 0.5 g/L to 1 g/L of propan-1-ol and from 0.001% (w/w) to 0.005% (w/w) of quinine hydrochloride and food products comprising the same are also disclosed.

### FIELD OF THE INVENTION

The present disclosure relates generally to the field of low-alcoholic and non-alcoholic liquid products and processes for producing the same.

### BACKGROUND OF THE INVENTION

The production of wines from fermented sugars found in grapes dates back to antiquity. The particular taste, aroma, and character of a wine is due to the grapes themselves and to the substances which are produced during grape fermentation (both alcoholic and malolactic fermentations), processing and maturation of the wine. The selection and growing of the grapes, from the grapevine genetic patrimony, and the wine production processes are managed to obtain the desired aroma, taste, and other characteristics of the wine.

Moderate wine consumption may be associated with specific health benefits and a healthy lifestyle. However, increased amounts of ethanol are cytotoxic and associated with adverse health outcomes. Alcohol reduction in wine might be an avenue to reduce alcohol related harm without forcing consumers to compromise on lifestyle and benefit from positive aspects of moderate consumption.

The grape initial amount of sugar determines the ethanol concentration of the initial wine, such that grape berries with a lower sugar concentration that produces a lower ethanol concentration initial wine. A reduction in grape berries sugar concentration can be achieved by various viticultural techniques such as reducing the leaf area of the grapevine. The ethanol concentration in wine can also be manipulated before, during and after fermentation by particular winemaking practices, such as blending of grape juices and musts, by choosing a low ethanol-producing yeast, or post-fermentation by blending with low strength juice and the physical removal of alcohol through distillation or membrane-based technologies.

U.S. Pat. No. 4,978,547A discloses a process for producing low alcoholic wine that includes the following steps: evaporating alcohol-containing wine in a vacuum evaporator so that a first mixture comprising water, alcohol and flavoring substance is separated from a second mixture having a low-alcoholic content, separating water from the first mixture in a multistage flavor substance apparatus and drawing off a third mixture comprising alcohol and flavoring substance, distilling alcohol from the third mixture, adding the water from the multistage flavor substance apparatus to a mixing vessel in an amount, which together with the low-alcohol second mixture and the flavoring substances produces a quantity of low-alcoholic wine having an alcoholic content below legally determined values for low-alcoholic wine, the process allowing only outputs of low-alcoholic wine, distilled alcohol and flavoring substances and inputs of essentially only the alcohol-containing wine.

Patent CN110777027A discloses a low-alcohol wine brewing method, which comprises the following steps: preparing grape into grape wine mash, and filling the grape wine mash into a fermentation tank; step two: adding SO₂ to the wine mash obtaining grape juice, after adding pectin and p-octyl benzoic acid; followed by alcoholic fermentation for 3-5 days. The method comprises stopping alcoholic fermentation when the alcohol concentration of fermentation liquor reaches 6.5-7% (v/v) and filtering to obtain a low-alcohol raw wine.

### SUMMARY OF THE INVENTION

In one aspect of the disclosure, there is provided a method for producing a non-alcoholic liquid product or a low-alcoholic liquid product, the method comprising nanofiltration, ultrafiltration, dialysis, or any combination thereof, of a grape mash with a sugar concentration from 8° Brix to 18° Brix, thereby obtaining a mixture with a sugar concentration from 10% to 50% less than the sugar concentration of the grape mash, and fermenting the mixture with one or more yeast during a period of time from 4 days to 8 days, thereby obtaining a liquid product.

In a further embodiment, the method comprises: nanofiltration of a grape mash with a sugar concentration from 8° Brix to 18° Brix, obtaining a first retentate and a first permeate; ultrafiltration of the first retentate, obtaining a second retentate and a second permeate; mixing the second retentate with the first permeate, thereby obtaining a mixture with a sugar concentration from 10% to 50% less than the sugar concentration of the grape mash; fermenting the mixture with one or more yeast during a period of time from 4 days to 8 days, thereby obtaining a liquid product.

In a further embodiment, the method comprises: dialysis of a grape mash with a sugar concentration from 8° Brix to 18° Brix, preferably with at least one membrane with a molecular weight cut-off (MWCO) from 10 kDa to 30 KDa, thereby obtaining a mixture with a sugar concentration from 10% to 50% less than the sugar concentration of the grape mash; fermenting the mixture with one or more yeast during a period of time from 4 days to 8 days, thereby obtaining a liquid product.

In a further embodiment, the reduction of the sugar concentration is from 40% to 50%.

In a further embodiment, the method further comprises a step of dealcoholize the liquid product, preferably by vacuum distillation, spinning cone column, evaporation, supercritical carbon dioxide (CO₂), reverse osmosis, or any combination thereof.

In a further embodiment, the mixture comprises an organic acid content from 5% to 10% less than of the organic acid concentration of the grape mash.

In a further embodiment, the one or more yeast is a low alcohol production yeast, preferably a non-saccharomyces yeast, more preferably a yeast selected from Lachancea thermotolerans, Metschnikowia fructicola, M. pulcherrima, Torulaspora delbrueckii, or any combination thereof.

In a further embodiment, the method comprises a step of adding to the liquid product an additive comprising propane-1,2,3-triol, propan-1-ol, quinine hydrochloride, or any combination thereof.

In a further embodiment, the method comprises a step of adding to the liquid product from 3 g/L to 12 g/L of propane-1,2,3-triol.

In a further embodiment, the method comprises a step of adding to the liquid product from 0.5 g/L to 1 g/L of propan-1-ol.

In a further embodiment, the method comprises a step of adding to the liquid product from 0.001% (w/w) to 0.005% (w/w) of quinine hydrochloride.

In a further embodiment, the method further comprises a step of clarification of the grape mash by enzymatic treatment, polyvinylpolypyrrolidone (PVPP), or both, wherein the step precedes nanofiltration, ultrafiltration, dialysis, or any combination thereof.

In a further embodiment, the ultrafiltration is performed with at least one membrane with a molecular weight cut-off (MWCO) from 7 kDa to 25 kDa.

In a further embodiment, the method further comprises separating the second permeate comprising a sugar concentration from 10° Brix to 25° Brix and an acidity from 2 g/L to 8.0 g/L, from the ultrafiltration step.

In another aspect of the disclosure, there is provided a composition obtained by the method of the present disclosure, comprising a sugar concentration from 10° Brix to 25° Brix and an acidity from 2 g/L to 8.0 g/L.

In another aspect of the disclosure, there is provided a composition obtained by the method of the present disclosure, comprising from 8% (v/v) to 10% (v/v) of alcohol, particularly 8.5% (v/v).

In another aspect of the disclosure, there is provided a composition obtained by the method of the present disclosure, comprising less than 4% (v/v) of alcohol, particularly 3.5% (v/v), 3% (v/v), 2% (v/v), 1% (v/v), 0.5% (v/v), or 0% (v/v).

In another aspect of the disclosure, there is provided a composition obtained by the method of the present disclosure, comprising less than 0.5% (v/v) of alcohol.

In another aspect of the disclosure, there is provided an additive comprising propane-1,2,3-triol, propan-1-ol, quinine hydrochloride, or any combination thereof, particularly from 3 g/L to 12 g/L of propane-1,2,3-triol, from 0.5 g/L to 1 g/L of propan-1-ol and from 0.001% (w/w) to 0.005% (w/w) of quinine hydrochloride, or any combination thereof.

In a further embodiment, the additive is a food additive.

In another aspect of the disclosure, there is provided a food product comprising the additive according to the present disclosure, preferably a beverage selected from juice, wine, hard seltzer, wine sangria, Ready to Drink beverage, cocktails, or any combination thereof.

In another aspect of the disclosure, there is provided a use of a composition according to the present disclosure, as a beverage.

In another aspect of the disclosure, there is provided a use of the additive according to the present disclosure, in wine industry, non-alcoholic beverages industry, low-alcoholic beverages industry, as nutraceutical and as adaptogenic beverages or any combination thereof.

### BRIEF DESCRIPTION OF THE DRAWINGS

Some embodiments of the disclosure are herein described, by way of example only, with reference to the accompanying drawings. With specific reference now to the drawings in detail, it is stressed that the particulars shown are by way of example and for purposes of illustrative discussion of embodiments of the disclosure. In this regard, the description taken with the drawings makes apparent to those skilled in the art how embodiments of the disclosure may be practiced.

FIG. 1 is a flowchart of a method for producing a non-alcoholic or a low-alcoholic liquid product, according to some embodiments of the present disclosure.

### DETAILED DESCRIPTION OF THE INVENTION

According to some embodiments, the present disclosure provides a method for producing a non-alcoholic liquid product or a low-alcoholic liquid product.

The present disclosure is based in part, on the finding that a method as described herein leads to new low-alcohol liquid products (e.g., beverages).

The present disclosure is based in part, on the finding that a method as described herein leads to production of grape-based beverages and totally or partially dealcoholized wine.

The present disclosure is based in part, on the finding that from the process as disclosed herein, liquid products with an alcohol content of less than 4% (v/v) can be obtained, such as: i. fruit (e.g., grape) must-based beverage: obtained by removing a significant part of the sugars in the must, followed by alcoholic fermentation to the desired level; and ii. totally or partially dealcoholized liquid product (e.g., wine): obtained by partially removing sugars, while leaving enough sugar content to ferment up to an alcoholic degree of 8.5% (v/v), followed by dealcoholizing to a desired final alcohol content.

As used herein, the terms “low-alcoholic liquid product” and “low-alcohol liquid product” refer to a liquid product with an alcohol content of less than 4% (v/v). In some embodiments, a low-alcoholic liquid product is a liquid product with an alcohol content from 0.5% (v/v) to 4% (v/v). As used herein, the terms “non-alcoholic liquid product” and “no-alcohol liquid product” refer to a liquid product with an alcohol content of less than 0.5% (v/v). In some embodiments, a low-alcoholic liquid product is a liquid product with an alcohol content from 0% (v/v) to 0.5% (v/v).

According to some embodiments, the present disclosure provides a method for producing a non-alcoholic liquid product or a low-alcoholic liquid product, the method comprising nanofiltration, ultrafiltration, dialysis, or any combination thereof, of a grape mash with a sugar concentration from 8° Brix to 18° Brix, thereby obtaining a mixture with a sugar concentration from 10% to 50% less than the sugar concentration of the grape mash.

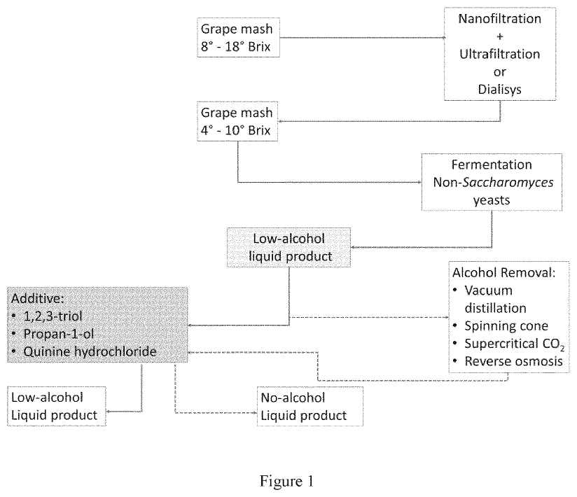

Reference is made to FIG. 1, which is a flowchart of a method according to some embodiments of the present disclosure. In some embodiments, nanofiltration, ultrafiltration, dialysis, or any combination thereof, of a grape mash with a sugar concentration from 8° Brix to 18° Brix, leads to a mixture (a second grape mash) with a sugar concentration from 4° Brix to 10° Brix.

In some embodiments, the method further comprises fermenting the mixture with one or more yeast during a period of time from 4 days to 8 days, thereby obtaining a liquid product.

The advantage, and technical effect obtained by such approach to partially or completely dealcoholize liquid products (e.g., wines), is the fact that the present method is based on a reduced alcohol removal, which leads to a reduced aroma removal, thereby leading to a product with maximized flavor compounds and nutritive ingredients from the fruit (e.g., grape).

According to some embodiments, the method comprises: nanofiltration of a grape mash with a sugar concentration between 8° Brix and 18° Brix, obtaining a first retentate and a first permeate. In some embodiments, the method further comprises: ultrafiltration of the first retentate, obtaining a second retentate and a second permeate; mixing the second retentate with the first permeate, thereby obtaining a mixture with a sugar concentration between 10% and 50% less than the sugar concentration of the grape mash. In some embodiments, the method further comprises fermenting the mixture with one or more yeast during a period of time between 4 days and 8 days, thereby obtaining a liquid product.

According to some embodiments, the method comprises: dialysis, preferably with a molecular weight cut off (MWCO) from 10 kDa to 30 KDa, thereby obtaining a mixture with a sugar concentration from 10% to 50% less than the sugar concentration of the grape mash. In some embodiments, the method further comprises fermenting the mixture with one or more yeast during a period of time from 4 days to 8 days, thereby obtaining a liquid product.

In some embodiments, the reduction of the sugar concentration is between 20% and 50%, between 30% and 50%, or between 40% and 50%, including any range therebetween. Each possibility represents a separate embodiment of the present disclosure.

In some embodiments, the grape is chosen based on its aromatic potential, according to its terpenes profile, phenolic profile, or any combination thereof.

The present disclosure is based in part, on the finding that, the grapes can be harvested at a specific moment for a predetermined sugar content (between 8 and 18° Brix), keeping their maximum organoleptic potential.

As used herein, the term “grape mash” refers to a must resulting from pressing fruit (grapes), that contains the skins, seeds, and stems of the fruit. The terms “grape mash” and “grape must” are used herein interchangeably.

In some embodiments, a liquid product according to the present disclosure is a beverage. As used herein, a “beverage” refers to a liquid intended for human consumption.

In some embodiments, the mixture comprises an organic acid content between 5% and 10% less than of the organic acid concentration of the grape mash. The present disclosure is based, in part, on the finding that the reduction of the organic acid content as described herein is important to keep the balance of the acid/sugar content in the mixture.

In some embodiments, the yeast is a low alcohol production yeast. In some embodiments, the yeast is a non-saccharomyces yeast. Low alcohol production yeast and non-saccharomyces yeast are well known to those skilled in the art. Non-limiting examples of suitable yeast according to the present disclosure include Lachancea thermotolerans, Metschnikowia fructicola, M. pulcherrima, Torulaspora delbrueckii, or any combination thereof.

According to some embodiments, the present disclosure provides a method for producing a non-alcoholic liquid product or a low-alcoholic liquid product, the method comprising a first step a) nanofiltration of a grape mash with a sugar concentration between 8° Brix and 18° Brix, obtaining a first retentate and a first permeate.

In some embodiments, the method comprises a second step b) ultrafiltration of the first retentate, obtaining a second retentate and a second permeate; followed by c) mixing the second retentate with the first permeate, thereby obtaining a mixture with a sugar concentration between 10% and 50% less than the sugar concentration of the grape mash. The present disclosure is based, in part, on the finding that the aromatic profile of the grape is not substantially affected by the filtration of the grape mash.

In some embodiments, the ultrafiltration is performed with at least one membrane with a molecular weight cut-off (MWCO) between 7 kDa and 25 kDa, between 8 kDa and 25 kDa, 9 kDa and 25 kDa, between 7 kDa and 20 kDa, between 8 kDa and 20 kDa, or between 9 kDa and 20 kDa, including any range therebetween. Each possibility represents a separate embodiment of the present disclosure. The present disclosure is based, in part, on the finding that the nanofiltration and ultrafiltration step and the choice of membrane as described herein, leads to the specific and desired ° Brix reduction.

In some embodiments, the method comprises a step d) fermenting the mixture with one or more yeast during a period of time between 4 days and 8 days, thereby obtaining a liquid product.

In some embodiments, the method as described hereinabove comprises a dialysis step. In some embodiments, the dialysis step is performed preferably with at least one membrane with a molecular weight cut off (MWCO) from 10 kDa to 30 KDa, from 11 kDa to 30 KDa, from 12 kDa to 30 KDa, from 10 kDa to 25 KDa, from 11 kDa to 25 KDa, from 12 kDa to 25 KDa, from 10 kDa to 20 KDa, from 11 kDa to 20 KDa, or from 12 kDa to 20 KDa, including any range therebetween. Each possibility represents a separate embodiment of the present disclosure. In some embodiments, the dialysis step is performed preferably with at least one membrane with a molecular weight cut off (MWCO) from 10 kDa to 30 KDa, more preferably from 11 kDa to 25 KDa, even more preferably from 12 kDa to 20 KDa. The technical effect obtained is the separation of sugars, thereby reducing the ° Brix, as well as separation of compounds responsible for aroma and color of the mixture.

The present disclosure is based, in part, on the finding that a membrane with a molecular weight cut off (MWCO) as described hereinabove, comprises an optimized MWCO range considering e.g., cost, benefit, efficiency and rational management of resources. It would be understood that according to the present disclosure, membranes with a different molecular weight could be used but with higher costs, no economic feasibility of the process.

In some embodiments, the dialysis step is performed at a temperature from 15° C. to 30° C., preferably from 18° C. to 25° C.

The present disclosure is based, in part, on the finding that a temperature range as described hereinabove comprises an optimized range resulting from data obtained in several tests. A range as described hereinabove comprises an optimized range considering e.g., cost, benefit, efficiency and rational management of resources.

The present disclosure is based, in part, on the finding that temperature has an important impact on dialysis kinetics and solubility of compounds in the area. Temperatures above 25° C. had a significant impact on the loss of compounds of interest (compounds responsible for aroma and color characteristics). Furthermore, the temperature was also selected taking into account the fermentation temperature and the reduction of operating costs of heating or cooling grape must to suit the fermentation conditions.

In some embodiments, the method as described hereinabove comprises dialysis of a grape mash with a sugar concentration between 8° Brix and 18° Brix. According to the method as described herein, the ratio from the volume of grape mash (V_{Mash}) and the volume of water (V_{water}) used in the dialysis is between 1:3 and 1:15, preferably between 1:5 and 1:10 (Vₘₐₛₕ/V_{water}).

The present disclosure is based, in part, on the finding that a ratio between the volume of grape mash (V_{Mash}) and the volume of water (V_{water}) as described hereinabove comprises an optimized range resulting from data obtained in several tests. A range as described hereinabove comprises an optimized range considering e.g., cost, benefit, efficiency and rational management of resources.

The present disclosure is based, in part, on the finding that a V_{Mash}/V_{water} ratio range as described herein, leads to the desired reduction in sugar, while reducing the use of water as much as possible.

Reference is made to FIG. 1, which is a flowchart of a method according to the present disclosure, comprising the steps as described hereinabove.

In some embodiments, the method further comprises a step of dealcoholize the liquid product, preferably by spinning cone column, evaporation, supercritical carbon dioxide (CO₂), reverse osmosis, or any combination thereof.

According to some embodiments, the method comprises a step of adding to the liquid product an additive comprising propane-1,2,3-triol, propan-1-ol, quinine hydrochloride, or any combination thereof.

According to some embodiments, the method comprises a step of adding to the liquid product an additive comprising between 3 g/L and 12 g/L of propane-1,2,3-triol, between 0.5 g/L and 1 g/L of propan-1-ol, between 0.001% (w/w) and 0.005% (w/w) of quinine hydrochloride, or any combination thereof.

In some embodiments, the method comprises a step of adding to the liquid product between 3 g/L and 12 g/L, between 4 g/L and 12 g/L, between 5 g/L and 12 g/L, between 7 g/L and 12 g/L, between 8 g/L and 12 g/L, between 10 g/L and 12 g/L, between 3 g/L and 10 g/L, between 4 g/L and 10 g/L, between 5 g/L and 10 g/L, between 7 g/L and 10 g/L, or between 8 g/L and 10 g/L of propane-1,2,3-triol, including any range therebetween. Each possibility represents a separate embodiment of the present disclosure.

In some embodiments, the method comprises a step of adding to the liquid product between 0.5 g/L and 1 g/L, between 0.6 g/L and 1 g/L, between 0.7 g/L and 1 g/L, between 0.5 g/L and 0.9 g/L, between 0.6 g/L and 0.9 g/L, or between 0.7 g/L and 0.9 g/L, of propan-1-ol, including any range therebetween. Each possibility represents a separate embodiment of the present disclosure.

In some embodiments, the method comprises a step of adding to the liquid product between 0.001% (w/w) and 0.005% (w/w), between 0.002% (w/w) and 0.005% (w/w), between 0.003% (w/w) and 0.005% (w/w), between 0.001% (w/w) and 0.004% (w/w), between 0.002% (w/w) and 0.004% (w/w), or between 0.003% (w/w) and 0.004% (w/w), of quinine hydrochloride, including any range therebetween. Each possibility represents a separate embodiment of the present disclosure.

The present disclosure is based, in part, on the finding that adding to the liquid product propane-1,2,3-triol, propan-1-ol, quinine hydrochloride, or any combination thereof, in the amounts and proportions as described hereinabove, provides to the liquid product a sensory profile balance capable of replacing the sensory role of alcohol.

The present disclosure is based, in part, on the finding that propane-1,2,3-triol, propan-1-ol and quinine hydrochloride can be added together or independently, depending on the physical-chemical and sensory characteristics of the desired liquid product (e.g., drink) to be produced.

In some embodiments, the method further comprises a step preceding step of clarification of the grape mash by enzymatic treatment, polyvinylpolypyrrolidone (PVPP), or both, wherein the step precedes nanofiltration, ultrafiltration, dialysis, or any combination thereof.

According to some embodiments, the method further comprises separating the second permeate comprising a sugar concentration between 10° Brix and 25° Brix and an acidity between 2 g/L and 8,0 g/L, from the ultrafiltration step.

According to some embodiments, the present disclosure provides a composition obtained by the method described hereinabove, comprising a sugar concentration between 10° Brix and 25° Brix and an acidity between 2 g/L and 8.0 g/L.

According to some embodiments, the present disclosure provides a use of the composition described hereinabove, as a beverage.

The present disclosure is based, in part, on the finding that the second permeate resulting from the ultrafiltration step, which is a by-product of the present method, can be used, in a circular economy perspective, for the production of beverages. Non-limiting examples include hard seltzers, ready to drink beverages, among others.

According to some embodiments, the present disclosure provides a composition obtained by the method described hereinabove, comprising between 8% (v/v) and 10% (v/v) of alcohol, particularly 8.5% (v/v). According to some embodiments, the present disclosure provides a use of the composition described herein, as a beverage.

According to some embodiments, the present disclosure provides a composition obtained by the method described hereinabove, comprising less than 4% (v/v) of alcohol, particularly 3.5% (v/v), 3% (v/v), 2% (v/v), 1% (v/v), 0.5% (v/v), or 0% (v/v). According to some embodiments, the present disclosure provides a use of the composition, as a beverage.

According to some embodiments, the present disclosure provides a composition obtained by the method described hereinabove, comprising less than 0.5% (v/v) of alcohol. According to some embodiments, the present disclosure provides a use of the composition, as a beverage.

According to some embodiments, the present disclosure provides an additive comprising propane-1,2,3-triol, propan-1-ol, quinine hydrochloride, or any combination thereof. In some embodiments, the additive comprises between 3 g/L and 12 g/L of propane-1,2,3-triol, between 0.5 g/L and 1 g/L of propan-1-ol and between 0.001% (w/w) and 0.005% (w/w) of quinine hydrochloride, or any combination thereof.

According to some embodiments of the present disclosure an additive as described comprises natural compounds, namely propan-1-ol (propanol) and propane-1,2,3-triol (glycerol), which are endogenous compounds of grape and wine.

In some embodiments, the additive comprises between 3 g/L and 12 g/L, between 4 g/L and 12 g/L, between 5 g/L and 12 g/L, between 7 g/L and 12 g/L, between 8 g/L and 12 g/L, between 10 g/L and 12 g/L, between 3 g/L and 10 g/L, between 4 g/L and 10 g/L, between 5 g/L and 10 g/L, between 7 g/L and 10 g/L, or between 8 g/L and 10 g/L of propane-1,2,3-triol, including any range therebetween. Each possibility represents a separate embodiment of the present disclosure.

In some embodiments, the additive comprises between 0.5 g/L and 1 g/L, between 0.6 g/L and 1 g/L, between 0.7 g/L and 1 g/L, between 0.5 g/L and 0.9 g/L, between 0.6 g/L and 0.9 g/L, or between 0.7 g/L and 0.9 g/L, of propan-1-ol, including any range therebetween. Each possibility represents a separate embodiment of the present disclosure.

In some embodiments, the additive comprises between 0.001% (w/w) and 0.005% (w/w), between 0.002% (w/w) and 0.005% (w/w), between 0.003% (w/w) and 0.005% (w/w), between 0.001% (w/w) and 0.004% (w/w), between 0.002% (w/w) and 0.004% (w/w), or between 0.003% (w/w) and 0.004% (w/w), of quinine hydrochloride, including any range therebetween. Each possibility represents a separate embodiment of the present disclosure.

In some embodiments, the additive is a food additive.

The present disclosure is based, in part, on the finding that an additive as described hereinabove, can be used in food, preferably in beverages, to replace the sensory role of ethanol (e.g., in wines).

According to some embodiments, the present disclosure provides a use of the additive as described hereinabove, in wine industry, non-alcoholic beverages industry, low-alcoholic beverages industry, as nutraceutical and adaptogenic beverages or any combination thereof.

The present disclosure is based, in part, on the finding that supplementation of a beverage with additive(s) comprising 3 to 12 g/L propane-1,2,3-triol, 0.5 to 1 g/L propan-1-ol, 0.001 to 0.005% quinine hydrochloride, or any combination thereof contribute to a greater sensory balance of the beverage and increases a sensory perception similar to ethanol. The choice of adding the described 3 compounds, only 1 compound or with a mixture of any 2 compounds, in the described amounts and ratios, can be made according to a desired beverage sensory profile. The sensory profile of a beverage can be tuned by tuning the amounts, ratios and compounds used.

An additive as described herein, can be added to beverages produced from grapes, or other beverages in order to promote a sensorial balance of the beverage and increase a sensorial perception similar to ethanol.

According to some embodiments, the present disclosure provides a food product comprising the additive described hereinabove, preferably a beverage selected from juice, wine, hard seltzer, wine sangria, Ready to Drink beverage, cocktails, or any combination thereof.

As used herein, the term “sensory profile” refers to a characteristic or characteristics such as appearance, aroma, flavor, taste, texture, or any combination thereof.

The terms “comprises”, “comprising”, “includes”, “including”, “having” and their conjugates mean “including but not limited to”.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this disclosure may be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination or as suitable in any other described embodiment of the disclosure. Certain features described in the context of various embodiments are not to be considered essential features of those embodiments, unless the embodiment is inoperative without those elements.

1. Method for producing a non-alcoholic liquid product or a low-alcoholic liquid product, the method comprising nanofiltration, ultrafiltration, dialysis, or any combination thereof, of a grape mash with a sugar concentration from 8° Brix to 18° Brix, thereby obtaining a mixture with a sugar concentration from 10% to 50% less than the sugar concentration of said grape mash; and fermenting said mixture with one or more yeast during a period of time from 4 days to 8 days, thereby obtaining a liquid product.

2. Method according to claim 1, comprising:
nanofiltration of a grape mash with a sugar concentration from 8° Brix to 18° Brix, obtaining a first retentate and a first permeate;
ultrafiltration of said first retentate, obtaining a second retentate and a second permeate;
mixing said second retentate with said first permeate, thereby obtaining a mixture with a sugar concentration from 10% to 50%, preferably from 40% to 50%, less than the sugar concentration of said grape mash;
fermenting said mixture with one or more yeast during a period of time from 4 days to 8days, thereby obtaining a liquid product;
preferably further comprising separating said second permeate comprising a sugar concentration from 10° Brix to 25° Brix and an acidity from 2 g/L to 8.0 g/L, from the ultrafiltration step.

3. Method according to claim 1, comprising:
dialysis of a grape mash with a sugar concentration from 8° Brix to 18° Brix, preferably with at least one membrane with a molecular weight cut-off (MWCO) from 10 kDa to 30 KDa, thereby obtaining a mixture with a sugar concentration from 10% to 50% less than the sugar concentration of said grape mash;
fermenting said mixture with one or more yeast during a period of time from 4 days to 8 days, thereby obtaining a liquid product.

4. (canceled)

5. Method according to claim 1, further comprising a step of dealcoholize said liquid product, preferably by spinning cone column, evaporation, supercritical carbon dioxide (CO₂), reverse osmosis, or any combination thereof.

6. Method according to claim 1, wherein said mixture comprises an organic acid content from 5% to 10% less than of the organic acid concentration of said grape mash.

7. Method according to claim 1, wherein said one or more yeast is a low alcohol production yeast, preferably a non-saccharomyces yeast, more preferably a yeast selected from Lachancea thermotolerans, Metschnikowia fructicola, M. pulcherrima, Torulaspora delbrueckii, or any combination thereof.

8. Method according to claim 1, comprising a step of adding to said liquid product an additive comprising propane-1,2,3-triol, propan-1-ol, quinine hydrochloride, or any combination thereof.

9. Method according to claim 1, comprising a step of adding to said liquid product from 3 g/L to 12 g/L of propane-1,2,3-triol.

10. Method according to claim 1, comprising a step of adding to said liquid product from 0.5 g/L to 1 g/L of propan-1-ol.

11. Method according to claim 1, comprising a step of adding to said liquid product from 0.001% (w/w) to 0.005% (w/w) of quinine hydrochloride.

12. Method according to claim 1, further comprising a step of clarification of said grape mash by enzymatic treatment, polyvinylpolypyrrolidone (PVPP), or both, wherein said step precedes nanofiltration, ultrafiltration, dialysis, or any combination thereof.

13. Method according to claim 1, wherein said ultrafiltration is performed with at least one membrane with a molecular weight cut-off (MWCO) from 7 kDa to 25 kDa.

14. (canceled)

15. Composition obtained by the method of claim 2, comprising a sugar concentration from 10° Brix to 25° Brix and an acidity from 2 g/L to 8.0 g/L.

16. Composition obtained by the method of claim 1, comprising from 8% (v/v) to 10% (v/v) of alcohol, particularly 8.5% (v/v) or less than 4% (v/v) of alcohol, particularly 3.5% (v/v), 3% (v/v), 2% (v/v), 1% (v/v), 0.5% (v/v), or 0% (v/v).

17. (canceled)

18. Composition obtained by the method of claim 5, comprising less than 0.5% (v/v) of alcohol.

19. Additive or a food additive comprising propane-1,2,3-triol, propan-1-ol, quinine hydrochloride, or any combination thereof, particularly from 3 g/L to 12 g/L of propane-1,2,3-triol, from 0.5 g/L to 1 g/L of propan-1-ol and from 0.001% (w/w) to 0.005% (w/w) of quinine hydrochloride, or any combination thereof.

20. (canceled)

21. Food product comprising the additive according to claim 19, preferably a beverage selected from juice, wine, hard seltzer, wine sangria, Ready to Drink beverage, cocktails, or any combination thereof.

22. Use of the composition according to claim 15, as a beverage.

23. Use of the composition according to claim 16, as a beverage.

24. (canceled)

25. Use of the composition according to claim 18, as a beverage.

26. Use of the additive according to claim 19, in wine industry, non-alcoholic beverages industry, low-alcoholic beverages industry, as nutraceutical, or any combination thereof.
